(19) United States
(12) Patent Application Publication
(10) Pub. No.: US 2007/0028746 A1
(43) Pub. Date: Feb. 8, 2007

(54) Multi-Funtional Pick For A Stringed Instrument

(76) Inventor: Michael Herring, Santa Cruz, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/198,263

(22) Filed: Aug. 4, 2005

(51) Int. Cl. G10D 3/16

(52) U.S. Cl. 84/322

(57) ABSTRACT

This invention relates to picks, used on string instruments, and particularly to picks incorporating electronics used to provide functionality to the pick and to enhance the experience by the user of playing a stringed instrument. Additional functionality may include a metronome, a tuner, and a decorative visual display.

### TECHNICAL FIELD

This invention relates to picks, used on string instruments, and particularly to picks incorporating electronics used to provide functionality to the pick and to enhance the experience by the user of playing a stringed instrument.

### BACKGROUND OF THE INVENTION

Hand-held picks are an accessory commonly used by musicians to pluck the strings of musical instruments, such as guitars, banjos, and others. Picks, particularly those for use with guitars and banjos, are typically thin, somewhat flexible, and include one or more picking tips protruding from an edge of the pick. For example, a typical modern guitar picks is a flat, thin, and tear-shaped, with the point of the “tear” used as the picking tip. These picks are typically held between the thumb and index finger and are used for sequentially plucking the strings.

Little progress has been made in the last few decades in the field of picks for stringed instruments, with the majority of development limited to improved gripping for the picks, tethers and the like to reduce the frequency which picks are lost, and improvements in the materials used in constructing the picks.

What is needed is a pick that incorporates modem electronic innovations to add new functionality to the pick and to enhance the decorative appearance of picks. What is further needed is a pick body that is ergonomic and easily grasped. What is further needed is a pick body providing a base for replaceable pick tips.

### SUMMARY OF THE INVENTION

The invention includes a pick for use on a stringed instrument. The pick includes apparatus allowing the pick to be an interactive tool for the musician. The apparatus may include but is not limited to electronic circuitry including printed circuit boards and electro-mechanical devices. In one preferred embodiment the musician can use the pick as a metronome and/or tuning director.

The apparatus includes a power supply coupling for providing power to a sensor mechanism and an output device. The sensor mechanism provides a driver signal to the output device, which provides an output signal outside the pick.

Stringed instruments capable of using a pick built in accord with the invention include but are not limited to a guitar, a banjo, an ukulele, a zither, a dulcimer, a lute, a mandolin, a koto, a Korean banjo, a Chinese banjo, a Japanese banjo, an oud, and an Indian plucked string instrument.

The output device may include one or more light emitting structure, and preferably multiple light emitting structures. The pick may include one or more lenses optically coupling with one or more of the light emitting structures to provide an optical signal outside the pick. The output device may include one or more output driver circuits translating the driver signal, or a component of the driver signal, into a signals presented to the light emitting structure.

The invention includes, in some embodiments, the pick tip for mounting between the cover and the base. The invention also includes the cover and the base.

The invention includes maintaining the pick, by mounting or removing or replacing the pick tip. The complete pick created by mounting the pick tip, is a product of this maintenance process.

The invention includes assembling the pick. The sensor mechanism, the output device, and the power supply coupling are electrically coupled to a printed circuit board to create a populated printed circuit board. The populated printed circuit board is placed in the base to create a populated base. The cover is coupled to the populated base to create the pick. The pick is a product of this assembly process.

The invention includes installing a power supply into the pick. The power supply is electrically coupled to the power supply coupling. The cover is coupled with the base to further contain the power supply, creating the powered pick. The powered pick is a product of this installation process.

The sensor mechanism may include a metronome used to create a metronome signal included in the driver signal. The metronome may include a configuration state determining the beat frequency for the metronome driver signal. The configuration state may be controlled by a configuration control circuit coupling to an input sensor.

The input sensor may include at least one of following. A pressure sensor mechanically coupled to a pick tip mounted between the cover and the base. At least one switch. And an external interface. The switch may include one or more of a push button, a pressure switch, and a thumb wheel. The external interface may feed an adapter to a computer interface. The adapter may support communication across one ore more wireline physical transports and/or wireless physical transports with the computer interface.

The apparatus of the invention may further include the sensor mechanism providing a sensor state to a processing mechanism. And the processing mechanism providing the driver signal to the output device based upon the sensor state.

The sensor mechanism may include one or more of the following. A clock timer providing a timed state, a pressure sensor mechanically coupling to the pick tip and providing a pressure state, and a microphone providing an acoustic state. The sensor state preferably includes whichever of the timed state, the pressure state and the acoustic state are provided.

The processing mechanism may include one or more of a finite state machine, a gate array, a field programmable logic device, and a computer accessibly coupled to a memory containing program steps of a program system directing the computer. The processing mechanism may include an operating state, and the operating state may include one or both of a perform-metronome state and a perform-tuning state.

### BRIEF DESCRIPTION OF THE DRAWINGS

FIG. 1 shows a simplified schematic of an apparatus of the invention used in a pick for a stringed instrument;

FIG. 2A shows the output device of FIG. 1A including a light emitting structure coupling with a lens to provide an optical signal included in the output signal;

FIG. 2B shows some details of the output device of FIGS. 1A and 2A;

FIGS. 3A to 5 shows various embodiments of the invention's pick of FIG. 1A;

FIG. 6A and 6B show some alternative embodiments of the power supply;

FIG. 6C shows the apparatus of FIG. 1A and 3A to 5 with a sensor mechanism including a metronome;

FIG. 6D shows the input sensor of FIG. 6C;

FIG. 7A shows some forms of the computer interface of FIG. 6D;

FIG. 7B shows the apparatus of FIGS. 1A, 3A to 5, and 6C including a processing mechanism;

FIG. 7C shows some details of the processing mechanism of FIG. 7B;

FIG. 8A shows some details of the sensor mechanism of FIG. 7B;

FIG. 8B shows some details of the operating state of FIG. 7B; and

FIG. 8C shows the processing mechanism of FIG. 7B coupled to the input sensor of FIG. 6D.

### DETAILED DESCRIPTION

This invention relates to picks, used on string instruments, and particularly to picks incorporating electronics used to provide functionality to the pick and to enhance the experience by the user of playing a stringed instrument.

The pick includes and uses apparatus to make the pick into an interactive tool for the musician. The apparatus may include but is not limited to electronic circuitry including printed circuit boards and electro-mechanical devices.

Picks built in accord with the invention can perform many desired functions including but not limited to the examples that follow. In one embodiment, the pick may incorporate a metronome which provides either visual or audible timing signals or displays, in another embodiment the pick may incorporate a tuner that allows the user to tune his or her instrument, in another embodiment, the pick may include light sources that provide a decorative visual display when desired. In still further embodiments the pick may be used to control music accessories such as speakers mixers, audio recorders, drum machines, microphones, digital signal processors, and audio effects hardware, and others. One preferred embodiment of the invention will be described in further detail below wherein the musician can use the pick as a metronome and/or tuning director. However, the invention is not limited to this example.

In a preferred embodiments, the apparatus includes a power supply coupling for providing power to a sensor mechanism and an output device. The sensor mechanism provides a driver signal to the output device, which provides an output signal outside the pick.

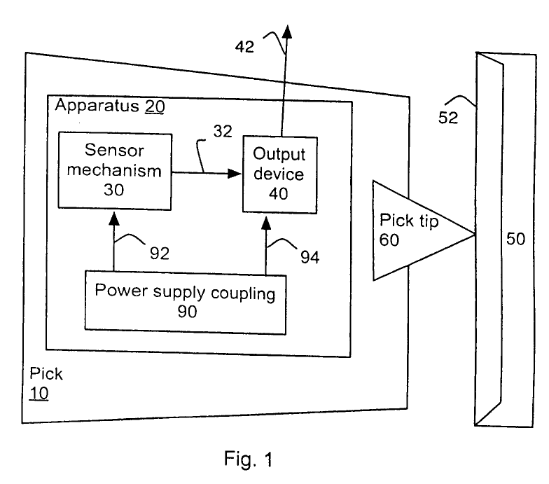

FIG. 1 shows a simplified schematic of an apparatus of the invention used in a pick for a stringed instrument. The invention includes an apparatus 20 used in a pick 10 on a stringed instrument. The apparatus includes a power supply coupling 90 for providing a sensor power 92 to a sensor mechanism 30 and an output power 94 to an output device 40. The sensor mechanism provides a driver signal 32 to the output device to provide an output signal 42 outside the pick. The pick preferably includes a pick tip 60, which is used to strike or strum at least one string 52 of the stringed instrument. In embodiments including a metronome function, the output device may provide either or both of a visual and audible timed signal. In embodiments including a tuning function, the pick may preferably provide a visual output understood by the user to display whether the stringed instrument is in tune, and in some embodiments, in what way the stringed instrument may be out of tune.

The stringed instrument may include but is not limited to a guitar, a banjo, an ukulele, a zither, a dulcimer, a lute, a mandolin, a koto, a Korean banjo, a Chinese banjo, a Japanese banjo, an oud, and an Indian plucked string instrument.

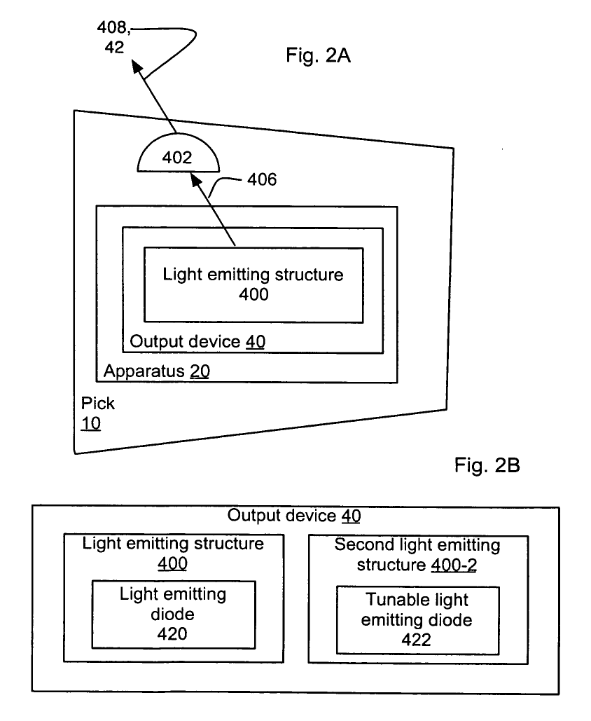

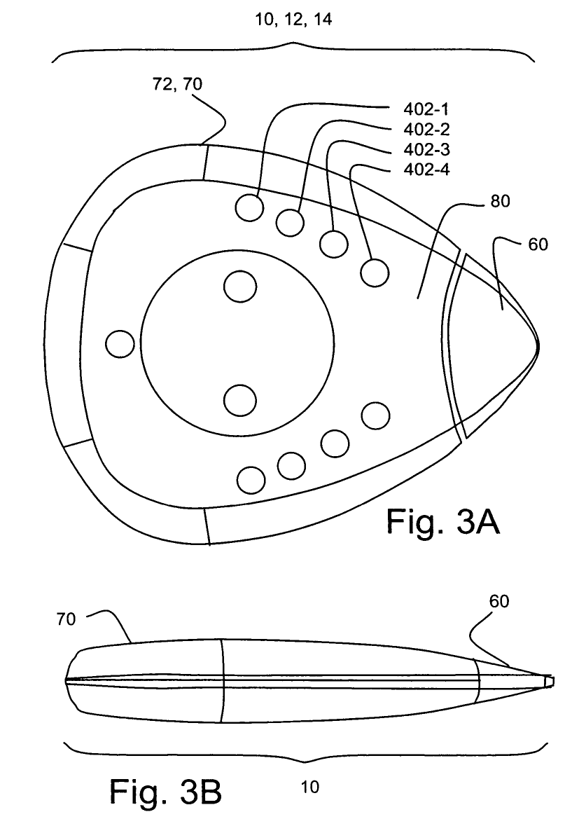

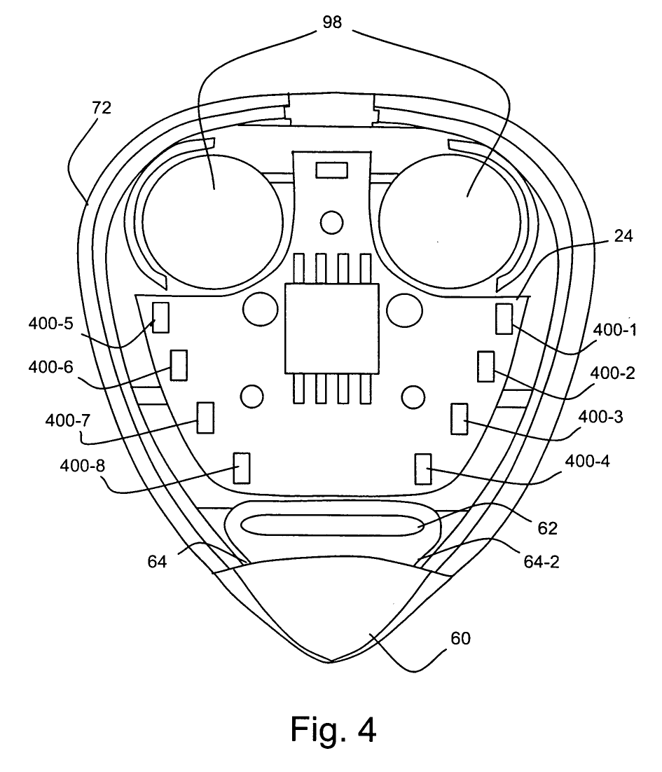

The output device may include one or more light emitting structures, and preferably multiple light emitting structures. In the Example embodiment seen in FIG. 1, device 40 preferably includes at least one light emitting structure 400. The light emitting structure may include an optical coupling 406 with a lens 402 included in the pick 10, which provides an optical signal 408 included in the output signal 42, as shown in FIG. 2A. The output device may include more than one light emitting structure, for example, the light emitting structure 400 and the second light emitting 400-2 shown in FIG. 2B. Each of the multiple light emitting structures may, at least partly, provide a separate optical signal included in the output signal. Each of the light emitting structures may separately or in combinations optically couple with more than one lens included in the pick, as shown in FIG. 3A and 4. One or more of the lenses may provide additional colors to the colors that are available from light emitting structure(s), or may be clear.

As used herein a light emitting structure 400 may include a light emitting diode 420 and/or a tunable light emitting diode 422. In other embodiments, additional light emitting structures may be usable. The output device 40 may alternatively include a radio transmitter providing a radio signal included in the output signal 42.

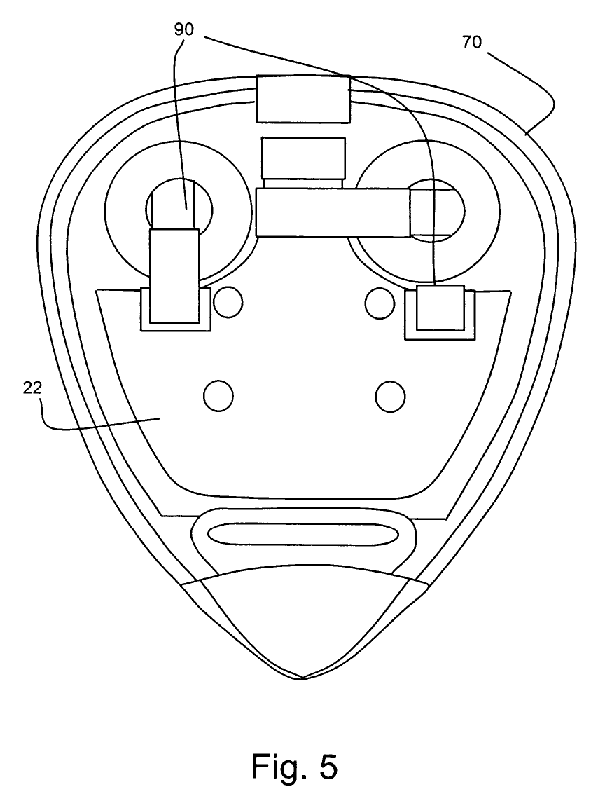

In some embodiments, the invention includes the pick tip 60 for mounting to the pick. I the embodiment shown, the pick tip mounts between the cover 80 and the base 70, as shown in FIGS. 1A, and 3A to 5. In this embodiment the pick tip may include one or more of the following: at least one side notch 64 and/or at least one alignment slot 62 fitting into the base when the cover couples with the base. FIG. 4 shows a pick tip including the side notch, a second side notch 64-2, and the alignment slot. However, other configurations for attaching the pick tip to the cover and or base of the pick may be useable. The pick tip may be primarily composed of any acceptable material including but not limited to a hard plastic, ivory, and steel.

The invention also includes the cover 80 and the base 70. The base is preferably hollow supporting at least one removable cover. The base and cover may include features intended to enhance the grip and or ergonomic function of the pick. The cover supports access to the apparatus 20 within the pick 10.

In the embodiment shown, the pick 10 has a relatively thick end and a relatively thin end on one comer of the triangular shape. The relatively thin end is the portion of the pick that is used to pick and strum the strings of the stringed instrument. Other configurations may be used in additional embodiments. In some embodiments, the pick may be about one inch in height measured from the pick top to the center of the upper side opposite the pick tip 60, and may have a width somewhat less than the height. In other embodiments, different dimension may be used.

The invention includes maintaining the pick, by mounting or removing the pick tip. The complete pick created by mounting the pick tip, is a product of this maintenance process.

The method of maintaining the pick 10 includes one or more of the following steps. Mounting the pick tip 60 between the cover 80 and the base 70 to create a complete pick 12, as shown in FIG. 3A. And removing the pick tip from between the cover and the base of the complete pick. This second operation is useful when the pick tip is worn out, or when the musician using the pick desires a different effect. The complete pick is a product of this process.

The invention includes assembling the pick. The sensor mechanism, the output device, and the power supply coupling are electrically coupled to a printed circuit board to create a populated printed circuit board. The populated printed circuit board is placed in the base to create a populated base. The cover is coupled to the populated base to create the pick. The pick is a product of this assembly process.

The method of assembling the pick 10 includes the following steps. Electrically coupling the sensor mechanism 30, the output device 40 and the power supply coupling 90 to a printed circuit board 22 to create a populated printed circuit board 24. Placing the populated printed circuit board in the base 70 to create a populated base 72 as shown in FIG. 4. And coupling the cover 80 to the populated base to create the pick. The pick is the product of this process.

The invention includes installing a power supply into the pick. The power supply is electrically coupled to the power supply coupling. The cover is coupled with the base to further contain the power supply, creating the powered pick. The powered pick is a product of this installation process.

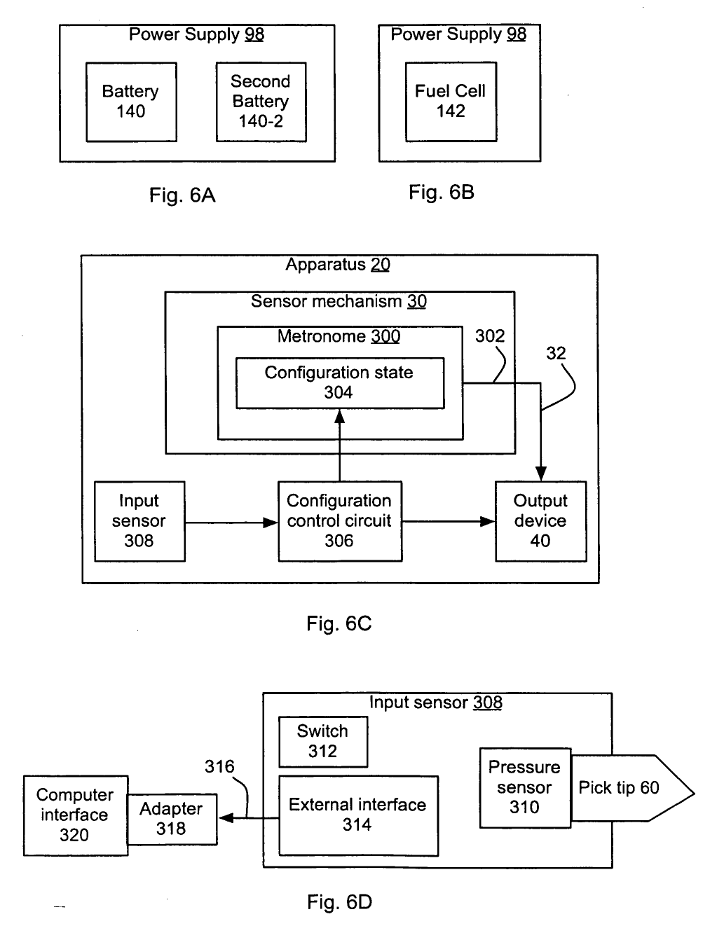

The method of installing a power supply 98 into the pick 10 includes the following steps. Electrically coupling the power supply to the power supply coupling 90 as shown in FIG. 4. And coupling the cover 80 to the base 70 to further contain the power supply to create a powered pick 14. The power supply includes a battery 140 or a fuel cell 142 as shown in FIGS. 6A and 6B. The power supply may further preferably include a second battery 140-2. The battery may be similar to those used in wristwatches. The batteries are strap-connected by the power supply coupling 90 in conventional fashion and replaceable. In some embodiments, inductive coupling may be used to power the pick or to charge batteries in the pick. In alternate embodiments, the batteries maybe external, for example in a wrist band worn by the user. In this embodiment a wire may extend between the external battery or batteries and electrically couple to the power supply coupling 90.

The sensor mechanism 30 may preferably include a metronome 300 used to create a metronome driver signal 302 included in the driver signal 32, as shown in FIG. 6C. The metronome may include a multi-stable vibrator such as the LM555.

The metronome 300 may further include a configuration state 304 determining a beat frequency for the metronome driver signal 302. The configuration state may be controlled by a configuration control circuit 306 coupling to an input sensor 308.

The input sensor 308 may include one or more of following, as in FIG. 6D. A pressure sensor 310 mechanically coupled to the pick tip 60 mounted between the cover 80 and the base 70. At least one switch 312. And an external interface 314. The switch may include one or more of a thumb pin, a push button, a pressure switch, and a thumb wheel. The thumb pin may include at least one electrode, that when closed by a thumb or finger, acts as a switch. The external interface may preferably feed an adapter 318 to a computer interface 320.

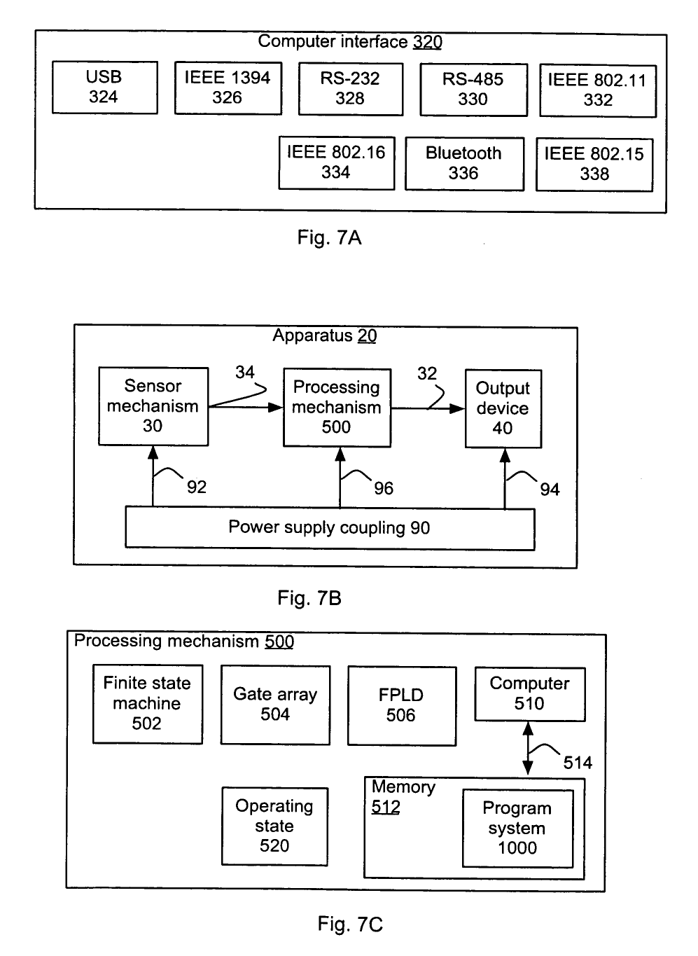

The adapter 318 may support communication across one or more wireline physical transports and/or one or more wireless physical transports with the computer interface 320. The following example computer interfaces of FIG. 7A require communication across wireline physical transport: a form of the Universal Serial Bus (USB 324), a form of IEEE 1394 326, a form of RS-232 328, and a form of RS-485 330. The following example computer interfaces require communication across one or more wireless physical transport a form of IEEE 802.11 332, a form of Bluetooth 336, a form of IEEE 802.15 338, and a form of IEEE 802.16 334. The computer interface is preferably compatible with one or more of these forms.

The apparatus 20 may further include the sensor mechanism 30 providing a sensor state 34 to a processing mechanism 500 as shown in FIG. 7B. The processing mechanism provides the driver signal 32 to the output device 40 based upon the sensor state. The power supply coupling 90 further provides a processor power 96 to the processing mechanism.

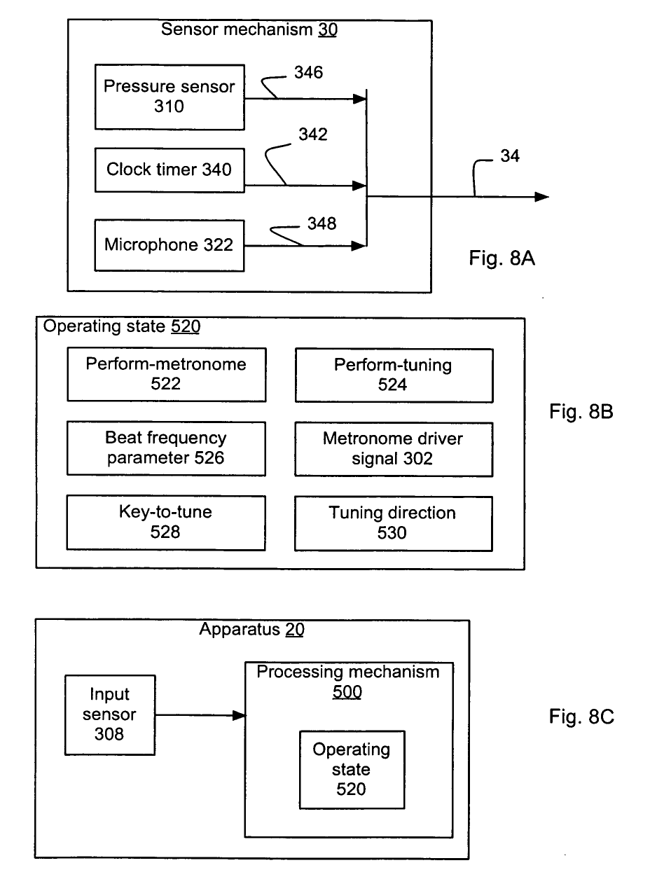

The sensor mechanism 30 may preferably include one or more of the following, as shown in FIG. 8A. A clock timer 340 providing a timed state 342. A pressure sensor 310 mechanically coupling to the pick tip 60 and providing a pressure state 346. And a microphone 322 providing an acoustic state 348. The pressure sensor preferably includes one or more of a piezoelectric sensor mechanically coupled to the pick tip and/or a magnetic pickup mechanically coupled to the pick tip.

The processing mechanism 500 preferably includes at least one instance of at least one of the following shown in FIG. 7C. A finite state machine 502, a gate array 504, a field programmable logic device 506, and a computer 510 accessibly coupled 514 to a memory 512 containing program steps of a program system 1000 directing the computer. The computer preferably includes at least one instruction processor and at least one data processor directed by at least one of the instruction processors.

The processing mechanism 500 may include an operating state 520. The operating state may preferably include at least one of a perform-metronome 522 and a perform-tuning 524, as shown in FIG. 8B. The operating state may further, preferably, include at least one of the following. A beat frequency parameter 526 used to control the beat frequency of the metronome driver signal 302 derived from the timed state 342. In certain embodiments, the timed state may include an interrupt request, possibly identifying a task to be triggered in the program steps of the program system 1000 of the computer. Also, the operating state may include a key-to-tune 528, used to control a tuning direction 530 determined from at least one of the pressure state 346 and the acoustic state 348.

The processing mechanism is preferably coupled to an input sensor to control the operating state, as shown in FIG. 8C

In use, the pick of the invention will include a means accessing the functions of the pick. In some embodiments, the functions are accessed through buttons on the pick. In other embodiments the functions are accessed through other means discussed herein or otherwise known in the art. For example, in embodiments using one or more buttons, the commands may be given by actuating the buttons in a series of holds, clicks, and double or triple clicks. Example parameters for a button embodiment may include but are not limited to, a hold characterized by the button being pressed and held for more than a second, a click by pressing the button between 64 ms and 1 second, a double click by pressing for greater than 64 ms and less than 1 second, then releasing for less than 0.5 seconds, then pressing for greater than 64 ms and less than 1 second, etc.

Embodiments configured for use as a metronome may be used as follows. The user activates the pick and selects the metronome function (if more than one fuinction is available). The user inputs commands setting the beat speed and timing desired and or other parameters including but not limited to selecting between visual and audible beats if both are available. The user then commands the pick to begin the metronome function in accord with the parameters selected. In a very simple design using a single button, an example implementation may include the following steps. The pick is activated by holding the button. The user then taps the button in a sequence up to a selected length by repeatedly pressing the button at timed intervals to program a metronome beat. The button is then held again to cause the pick to repeat the sequence tapped in by the user either visually or audibly so that the pick is now acting as a metronome. In some embodiments, the visual metronome signal may also optionally function as a decorative visual display.

Embodiments configured for use as a tuner may be used as follows. The user activates the pick and selects the tuning function (if more than one function is available). The user may enter commands to select the string to be tuned, or in some embodiments the pick may automatically recognize the string to be tuned. The user plucks the string to be tuned and pick displays a visual or audible signal informing the user as to whether the string is in tune. In some embodiments the pick may show whether an out of tune string is sharp or flat in order to assist the user in tuning the string. When the user is done, the pick may be manually deactivated, or may automatically deactivate after a preset period of time. In a very simple design using a single button, an example implementation may include the following steps. The pick is activated by holding the button. The user then taps once to inform the pick that string one will be played. The user plays string one. The pick in this embodiment may include a row of at least three lights. If the string is in tune, the center light illuminates, if the string is flat, the left hand light illuminates, and if the string is sharp the right hand light illuminates. The user adjusts the tension on the guitar string, if necessary, and plays again to determine if the string is now in tune. In this example embodiment, string two might be selected by double clicking, and string three by triple clicking, etc.

Embodiments configured for use in generating a decorative visual display may be used as follows. The user activates the pick and selects the display function (if more than one function is available). The user inputs commands selecting a desired display. The user then commands the pick to begin the display. When the user is done, the pick may be manually deactivated, or may automatically deactivate after a preset period of time. In a very simple embodiment using a single control button, and having a plurality of light sources for generating a visual display, an example implementation may include the following steps. The pick is activated by holding the button. The user then taps the button and a first pre-programmed visual display sequence is displayed. Tapping the button again will cause a second pre-programmed visual display to appear. Repeated tapping will step sequentially through a preprogrammed set of visual displays. In other embodiments, the user may be able to program a visual display, possibly in a manner similar to that explained in the example method described above for use of an embodiment configured for use as a metronome.

The preceding embodiments provide examples of the invention and are not meant to constrain the scope of the following claims.

What is claimed is:

1. A pick for a stringed instrument comprising:
at least one power supply providing power to at least one of a sensor mechanism or an output device; and
said sensor mechanism providing a driver signal to said output device to provide an output signal.

2. The pick of claim 1 wherein said stringed instrument is at least one of a form of a guitar, a banjo, an ukulele, a zither, a dulcimer, a lute, a mandolin, a koto, a Korean banjo, a Chinese banjo, a Japanese banjo, an oud, and an Indian plucked string instrument.

3. The pick of claim 1 wherein said output device includes at least one light emitting structure.

4. The pick of claim 1 further comprising a housing including a base and a cover.

5. The pick of claim 1, further comprising a pick tip for mounting to said housing.

6. The pick tip of claim 5 configured for mounting between said based and said cover.

7. The pick tip of claim 5 primarily composed of at least one of: a hard plastic, ivory, and metal.

8. A method of maintaining the pick of claim 4 comprising at least one of the steps:
removing a first pick tip from said housing; and
attaching a second pick tip to said housing.

9. A complete pick as a product of the process of claim 8.

10. A method of assembling said pick of claim 7, comprising the steps:
electrically coupling said sensor mechanism, said output device, and a power supply coupling to a printed circuit board to create a populated printed circuit board;
placing said populated printed circuit board in said base to create a populated base;
coupling a pick tip to said housing; and
coupling said cover to said populated base.

11. The pick as a product of the process of claim 10.

12. A method of installing said power supply into said pick of claim 10, comprising the step: electrically coupling said power supply to said power supply coupling.

13. The powered pick as a product of the process of claim 12.

14. The pick of claim 1, wherein said sensor mechanism, includes a metronome used to create a metronome driver signal included in said driver signal.

15. The pick of claim 14, wherein said metronome includes a configuration state for selecting a beat frequency for said metronome driver signal.

16. The pick of claim 15, wherein said configuration state is controlled by a configuration control circuit coupling to an input sensor.

17. The pick of claim 1, wherein said input sensor, includes at least one of: a pressure sensor mechanically coupled to a pick tip; at least one switch; and an external interface.

18. The pick of claim 17, wherein said external interface communicates with a computer interface.

19. The pick of claim 18, wherein said external interface communicates with a computer interface across at least one of a wireless physical transport and a wireline physical transport with said computer interface.

20. The pick of claim 1, futher comprising said sensor mechanism providing a sensor state to a processing mechanism; and said processing mechanism providing said driver signal to said output device based upon said sensor state.

21. The pick of claim 20, wherein said processing mechanism, includes: an operating state wherein said operating state, includes at least one of a perform-metronome function and a perform-tuning function

22. The pick of claim 21 wherein said processing mechanism is coupled to an input sensor to control said operating state.
